(19) United States
(12) Patent Application Publication
(10) Pub. No.: US 2025/0131777 A1
(43) Pub. Date: Apr. 24, 2025

(54) DATA PROVISION PLATFORM, DATA PROVISION SYSTEM, DATA PROVISION METHOD, AND PROGRAM

(71) Applicant: DENSO CORPORATION, Kariya-city (JP)

(72) Inventor: Ryota SAITO, Kariya-city (JP)

(21) Appl. No.: 19/006,046

(22) Filed: Dec. 30, 2024

Related U.S. Application Data
(63) Continuation of application No. PCT/JP2023/023807, filed on Jun. 27, 2023.

(30) Foreign Application Priority Data
Jul. 7, 2022 (JP) 2022-109821

(51) Int. Cl. G07C 5/00; G06F 12/02; G07C 5/04

(52) U.S. Cl. CPC G07C 5/008; G06F 12/023; G07C 5/04; G06F 2212/173

(57) ABSTRACT

A data provision platform, a data provision system, a data provision method, or a program repeatedly acquires instantaneous data that is an instantaneous value of vehicle data transmitted from each unit of a vehicle, stores a time-series of the instantaneous data, extracts the instantaneous data of a request data, provide the instantaneous data to s data use unit, and attach a characteristic value to the instantaneous data provided to the data use unit, the characteristic value being: specified in advance according to request data and generated based on the time-series.

### CROSS REFERENCE TO RELATED APPLICATIONS

The present application is a continuation application of International Patent Application No. PCT/JP2023/023807 filed on Jun. 27, 2023, which designated the U.S. and claims the benefit of priority from Japanese Patent Application No. 2022-109821 filed on Jul. 7, 2022. The entire disclosures of all of the above applications are incorporated herein by reference.

### TECHNICAL FIELD

The present disclosure relates to a technology for collecting vehicle data and providing it on request.

### BACKGROUND

For example, a technology for remotely monitoring a vehicle has been known.

### SUMMARY

A data provision platform, a data provision system, a data provision method, or a program repeatedly acquires instantaneous data that is an instantaneous value of vehicle data transmitted from each unit of a vehicle, stores a time-series of the instantaneous data, extracts the instantaneous data of a request data, provide the instantaneous data to s data use unit, and attach a characteristic value to the instantaneous data provided to the data use unit, the characteristic value being: specified in advance according to request data and generated based on the time-series.

### BRIEF DESCRIPTION OF THE DRAWINGS

FIG. 1 is a block diagram showing a configuration of a mobility service provision system according to a first embodiment.

FIG. 2 is a functional block diagram showing a configuration of the mobility service provision system.

FIG. 3 is an explanatory diagram illustrating a relationship between a data generation cycle by a vehicle function, a data acquisition cycle by an application, and a period for calculating a characteristic value of vehicle data.

FIG. 4 is an explanatory diagram illustrating contents of a data attachment policy.

FIG. 5 is a flowchart of a data collection distribution process.

FIG. 6 is a flowchart showing a data attachment process.

FIG. 7 is a sequence diagram showing operation in an in-vehicle system.

FIG. 8 is a block diagram showing a configuration of the mobility service provision system according to a second embodiment.

FIG. 9 is an explanatory diagram illustrating a period during which the characteristic value of vehicle data is calculated according to the second embodiment.

FIG. 10 is a flowchart of the data collection distribution process according to the second embodiment.

FIG. 11 is a flowchart of the data attachment process according to the second embodiment.

### DETAILED DESCRIPTION

With the increasing performance of computer resources installed in vehicles and network connection of vehicles, a system has been constructed that enables continuous addition and update of applications even after the vehicles have been shipped to the market. In the future, in such an environment, applications are expected to be separated from in-vehicle devices such as ECUs and provided by various suppliers, including third parties.

However, after detailed examination by the inventor, it has been found that it is difficult to set an observation period according to data characteristics (that are generation period and time responsiveness) in an environment where unspecified applications run on multiple types and models. That is, since multiple applications are likely to utilize general-purpose lines in time divisions, the increase in the number of applications running simultaneously may not ensure the sufficient observation period required by the application. In addition, applications provided by suppliers may not always be created to observe at sufficient intervals. In addition, when the sufficient observation period cannot be ensured, the operation change of the application such as missing instantaneous changes in the data is not correctly recognized. Therefore, there are concerns that the operation of the application is obstructed.

One example of the present disclosure provides a technology that enables accurate grasp of change in vehicle data regardless of an observation period of the vehicle data.

According to one example embodiment of the present disclosure, a data provision platform includes a data collection unit, a data storage, a data provision unit, and a data attachment unit. The data collection unit repeatedly acquires instantaneous data that is an instantaneous value of vehicle data transmitted from each unit of a vehicle. The data storage stores a time-series of the instantaneous data acquired by the data collection unit. When accepting a data acquisition request from at least one data use unit configured to execute a process using the vehicle data, the data provision unit extracts the instantaneous data of a request data that is the vehicle data indicated by the data acquisition request, the instantaneous data being stored in the data storage, and provides the instantaneous data to the data use unit. The data attachment unit attaches a characteristic value that is predetermined according to the request data, and the characteristic value generated based on the time-series of the instantaneous data stored in the data storage for the request data, to the instantaneous data that the data provide unit provides to the data use unit.

According to such a configuration, regardless of the length of the data acquisition interval, it is possible to cause the request source application to accurately understand the variation of the request data that occurred during the data acquisition interval.

According to another example embodiment of the present disclosure, a data provision system includes: a data collection device communicably connected to an electronic control unit of a vehicle; and a server communicably connected to the vehicle.

The data collection device includes a data collection unit, a data storage, a data provision unit, and a data attachment unit. The data collection unit repeatedly acquires instantaneous data that is an instantaneous value of vehicle data transmitted from each unit of a vehicle, and transmits the acquired instantaneous data to the server. The data storage stores a time-series of the instantaneous data acquired by the data collection unit. When accepting a data acquisition request from at least one data use unit configured to execute a process using the vehicle data, the data provision unit extracts the instantaneous data of a request data that is the vehicle data indicated by the data acquisition request, the instantaneous data being stored in the data storage, and provides the instantaneous data to the data use unit. The data attachment unit attaches a characteristic value that is predetermined according to the request data, and the characteristic value generated based on the time-series of the instantaneous data stored in the data storage for the request data, to the instantaneous data that the data provide unit provides to the data use unit.

The server includes a server data storage. The server data storage stores the time-series of the instantaneous data transmitted from the vehicle.

According to such a configuration, it is possible to implement the function of the data providing platform described above by configurations in the vehicle.

According to another example embodiment of the present disclosure, a data provision system includes: a data collection device communicably connected to an electronic control unit of a vehicle; and a server communicably connected to the vehicle.

The data collection device includes a data collection unit. The data collection unit repeatedly acquires instantaneous data that is an instantaneous value of vehicle data transmitted from each unit of a vehicle, and transmits the acquired instantaneous data to the server.

The server includes a vehicle data storage, a data provision unit, and a data attachment unit. The data provision unit stores a time-series of the instantaneous data received from the data collection device.

When accepting a data acquisition request from at least one data use unit configured to execute a process using the vehicle data, the data provision unit extracts the instantaneous data of a request data that is the vehicle data indicated by the data acquisition request, the instantaneous data being stored in the vehicle data storage, and provides the instantaneous data to the data use unit. The data attachment unit attaches a characteristic value that is predetermined according to the request data, and the characteristic value generated based on the time-series of the instantaneous data stored in the data storage for the request data, to the instantaneous data that the data provide unit provides to the data use unit.

According to such a configuration, it is possible to implement the function of the data providing platform described above by configurations in the server.

According to another example embodiment of the present disclosure, a data provision method includes repeatedly acquiring instantaneous data that is an instantaneous value of vehicle data transmitted from each unit of a vehicle; storing a time-series of the instantaneous data in a data storage. Further, the data provision method includes, when accepting a data acquisition request from at least one data use unit configured to execute a process using the vehicle data, extracting the instantaneous data of a request data that is the vehicle data indicated by the data acquisition request, the instantaneous data being stored in the data storage; providing the instantaneous data to the data use unit; and Furthermore, the data provision method includes attaching a characteristic value that is predetermined according to the request data, and the characteristic value generated based on the time-series of the instantaneous data stored in the data storage for the request data, to the instantaneous data provided to the data use unit.

According to such a method, regardless of the length of the data acquisition interval, it is possible to cause the request source application to accurately understand the variation of the request data that occurred during the data acquisition interval.

According to another example embodiment of the present disclosure, a program causes a computer to implement the following functions.

The functions implemented by the program using the computer include: a function of repeatedly acquiring instantaneous data that is an instantaneous value of vehicle data transmitted from each unit of a vehicle; and storing a time-series of the instantaneous data in a data storage. The functions implemented by the program using the computer include: a function of, when accepting a data acquisition request from at least one data use unit configured to execute a process using the vehicle data, extracting the instantaneous data of a request data that is the vehicle data indicated by the data acquisition request, the instantaneous data being stored in the data storage, and a function of providing the instantaneous data to the data use unit. The functions implemented by the program using the computer include a function of attaching a characteristic value to the instantaneous data to the data use unit, the characteristic value being: specified in advance according to the request data and generated based on the time-series of the instantaneous data stored in the data storage.

By executing such a program, it is possible to implement the effect by the above data provision method.

Hereinafter, embodiments of the present disclosure will be described with reference to drawings.

### 1. First Embodiment

### 1-1. Outline of System

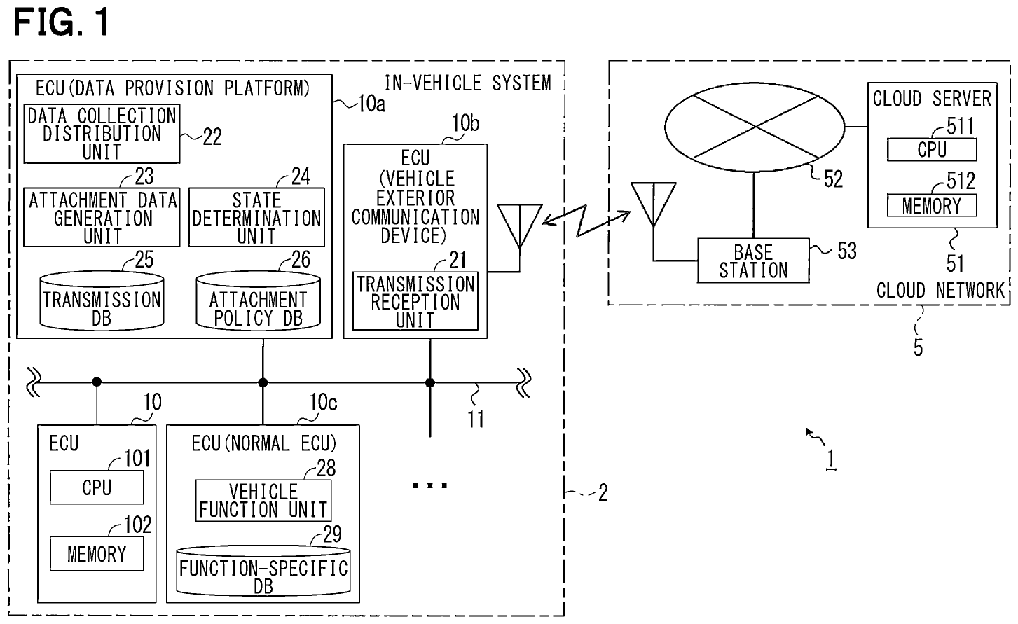

A mobility service provision system 1 of the present embodiment includes an in-vehicle system 2 mounted in a vehicle, and a cloud network 5, as shown in FIG. 1. The in-vehicle system 2 is mounted in the vehicle. The vehicle may have an automated driving function in addition to a manual driving function. The vehicle may be a hybrid vehicle having an engine and an electric motor as a traveling source. The vehicle may be a vehicle having only the manual driving function, not limited to a vehicle having the automated driving function and the hybrid vehicle. Hereinafter, the vehicle equipped with the in-vehicle system 2 will be simply referred to as a vehicle.

### 1-1-1. Cloud Network

The cloud network 5 includes a cloud server 51 and a wide area wireless communication network 52.

The cloud server 51 is connected to the wide area wireless communication network 52 and has a function of performing data communication between multiple in-vehicle systems 2 via a base station 53 belonging to the wide area wireless communication network 52. There may be multiple cloud servers 51. The cloud server 51 is an electronic control unit mainly including a CPU 511 and a microcomputer equipped with a semiconductor memory (hereinafter referred to as a memory) 512 such as a ROM and a RAM. Various functions of the cloud server 51 are implemented by the CPU 511 executing a program stored in a non-transitory tangible storage medium. In this example, the memory 512 corresponds to a non-transitory tangible storage medium storing the program. Further, by executing this program, a method corresponding to the program is executed. Note that partial or all of the functions executed by a CPU 101 may be implemented by a hardware circuit, such as one or more ICs. Further, the number of microcomputers constituting an ECU 10 may be one or more.

The cloud server 51 provides various services using the mobility service provision system 1. The service provided by the cloud server 51 can be, for example, a service for managing the driving operation of a vehicle or a service for collecting data necessary for generating an algorithm of the automated driving.

The memory 512 of the cloud server 51 has at least an area for storing the instantaneous data which is the instantaneous value of the vehicle data transmitted from the in-vehicle system 2 in a time-series manner.

Here, although the cloud server 51 is exemplified as the server providing the service, a server configured in an on-premises manner may be used instead of the cloud server 51.

### 1-1-2. In-Vehicle System

The in-vehicle system 2 includes multiple ECUs 10. The ECU is an abbreviation for Electronic Control Unit. The multiple ECUs 10 are connected to each other via a vehicle interior communication network 11. The vehicle interior communication network 11 is used, for example, CAN and Ethernet. The CAN is an abbreviation for Controller Area Network. Both CAN and Ethernet are registered trademarks.

The in-vehicle system 2 is mounted in the vehicle and has a function to perform data communication with the cloud server 51 via the base station 53 connected to the wide area wireless communication network 52.

The ECU 10 is an electronic control unit mainly including the CPU 101 and a microcomputer having a semiconductor memory (hereinafter referred to as memory) 102 such as a ROM and a RAM. Various functions of the microcomputer are implemented by the CPU 101 executing a program stored in a non-transitory tangible storage medium. In this example, the memory 102 corresponds to the non-transitory tangible storage medium storing the program. Further, by executing this program, a method corresponding to the program is executed. Note that partial or all of the functions executed by the CPU 101 may be implemented by a hardware circuit, such as one or more ICs. Further, the number of the microcomputers constituting the ECU 10 may be one or more.

The multiple ECUs 10 implement functions assigned to each of them. Here, the ECU 10 having the function of collecting and distributing vehicle data is called a data provision platform 10a, and the ECU 10 having the function of communicating with the cloud network 5 is called a vehicle exterior communication device 10b. In addition, the ECU 10 other than the data provision platform 10a and the vehicle exterior communication device 10b is called a normal ECU 10c. The normal ECU 10c executes processes to implement the vehicle functions assigned to each one. The vehicle functions may include, for example, functions for implementing hybrid control, engine control, stop and start control, transmission control, airbag control, power steering control, charging control, etc.

The data provision platform 10a and the vehicle exterior communication device 10b may be configured as a single ECU 10 or integrated with another normal ECU 10c, and the like.

### 1-2. Functional Configuration

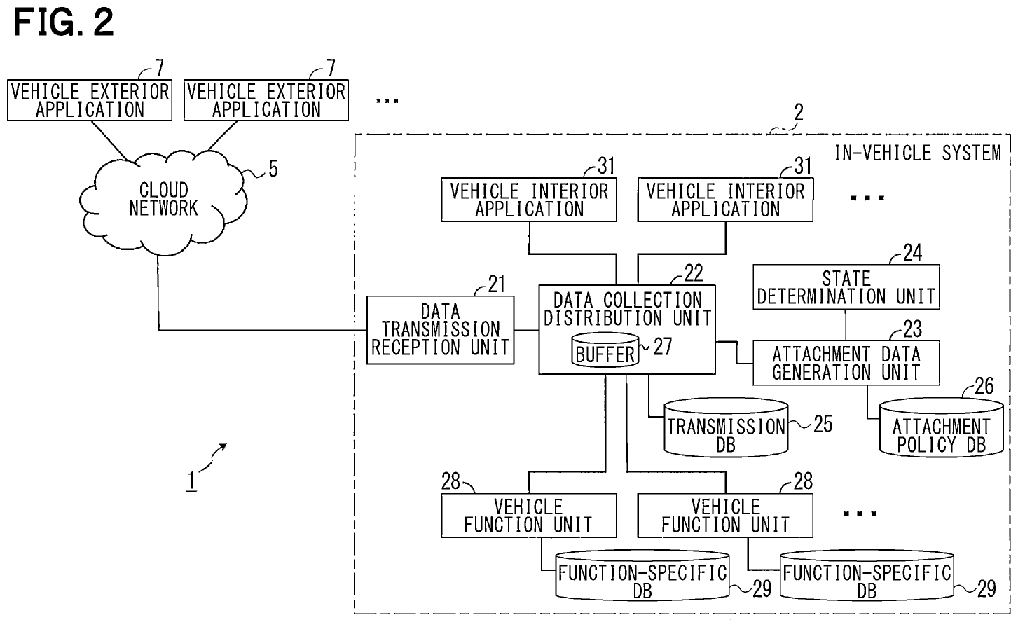

The functional configuration of the mobility service provision system 1 will be described using FIGS. 1 and 2.

The in-vehicle system 2 includes a transmission reception unit 21. The transmission reception unit 21 is implemented by processes executed by the CPU of the vehicle exterior communication device 10b.

The in-vehicle system 2 includes a data collection distribution unit 22, an attachment data generation unit 23, a state determination unit 24, a transmission DB 25, and an attachment policy DB 26. The data collection distribution unit 22, the attachment data generation unit 23, and the state determination unit 24 are implemented by processes executed by the CPU of the data provision platform 10a. The transmission DB 25 and the attachment policy DB 26 are provided in the memory of the data provision platform 10a.

The in-vehicle system 2 includes multiple vehicle function units 28, and multiple function-specific DBs 29. Each of the vehicle function units 28 is implemented by processes executed by the CPU of one of the normal ECUs 10c. Each function-specific DB 29 is provided in the memory of one of the normally ECU 10c.

The in-vehicle system 2 may include one or more vehicle interior applications (hereinafter also referred to as vehicle interior app) 31. The vehicle interior application 31 is obtained, for example, from the cloud server 51 and implemented in one of the ECUs 10 belonging to the in-vehicle system 2. Multiple vehicle interior applications 31 may be implemented in one ECU 10.

The cloud server 51 or the terminal operated by the service provider on the cloud network 5 may include one or more vehicle exterior applications (hereinafter also referred to as vehicle exterior app) 7 that provide services using vehicle data collected by the in-vehicle system 2. The vehicle exterior application 7 accesses the in-vehicle system 2 via the cloud network 5 to acquire vehicle data collected by the vehicle function unit 28 of the in-vehicle system 2, and the like.

The vehicle function unit 28 repeatedly collects the instantaneous value (hereinafter referred to as instantaneous data) of the vehicle data related to the vehicle function assigned to it, and stores it in the function-specific DB 29 and transmits the latest instantaneous data to the data provision platform 10a. The vehicle data collected by the vehicle function unit 28 may include, for example, the position of the vehicle, the speed and acceleration of the vehicle, the steering angle, the rotation speed of the engine, and the like. The data generation cycle representing the frequency of generation of vehicle data in the vehicle function unit 28 may be fixed or may be set variable according to an external instruction.

The data collection distribution unit 22 temporarily stores the instantaneous data received from the vehicle function unit 28 in a ring buffer 27 provided for each type of vehicle data. In other words, the contents of the ring buffer 27 are updated every time new instantaneous data is received, and the latest predetermined number of instantaneous data is always stored for each type of vehicle data. The data collection distribution unit 22 periodically transmits these instantaneous data to the cloud server 51 via the transmission reception unit 21. The data collection distribution unit 22 may transmit the received instantaneous data to the cloud server 51 whenever it receives the instantaneous data from the vehicle function unit 28.

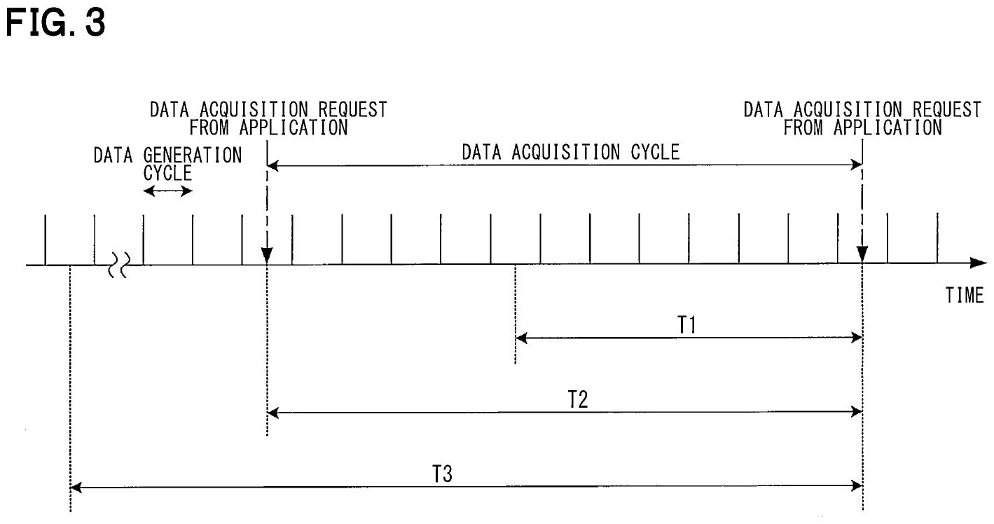

Normally, as shown in FIG. 3, the data request period in which the vehicle interior application 31 or the vehicle exterior application 7 requests acquisition of vehicle data is set to a length equal to or greater than the data generation cycle by the vehicle function unit 28. Then, the number of instantaneous data (hereinafter also referred to as a buffer data number) stored in the ring buffer 27 is set to a number that can accommodate, for example, vehicle data collected during the data acquisition cycle without leakage. However, the buffer data number may be more or less than this. In addition, the buffer data number may be different for each type of vehicle data.

The data collection distribution unit 22 accepts a request for data acquisition by the vehicle interior application 31 and also accepts a request for data acquisition by the vehicle exterior application 7 through the transmission reception unit 21. When the data collection distribution unit 22 accepts the data acquisition request, it stores the latest instantaneous data stored in the ring buffer 27 in the transmission DB 25 for the request data, which is the vehicle data indicated in the data acquisition request. In addition, the data collection distribution unit 22 provides, to the attachment data generation unit 23, a time-series (hereinafter referred to as a request data series) of instantaneous data about the request data stored in the ring buffer 27.

The attachment data generation unit 23 generates characteristic values that become attachment data based on the request data series provided by the data collection distribution unit 22 in accordance with the data attachment policy stored in the attachment policy DB 26, and stores it in the transmission DB 25. The characteristic value may be a physical value representing the characteristic, or data indicating a trend of change in the value (for example, monotonic increase and monotonic decrease, and the like). The characteristic value is data indicating features of the request data series in a predetermined period regarding the instantaneous data about the request data.

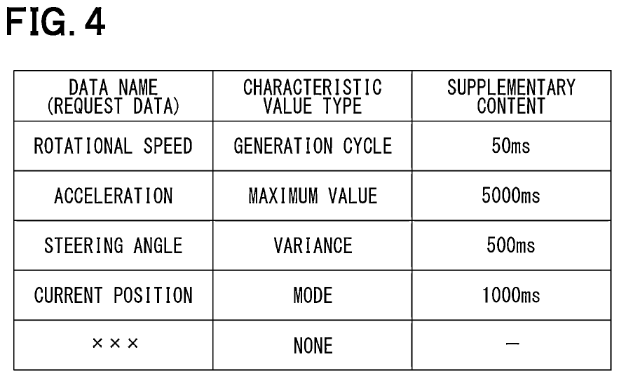

The data attachment policy is represented by a table as shown in FIG. 4. Table items include data name, characteristic value type, and supplementary content.

The data name is the name of the vehicle data (that is, the request data) that is acquisition data indicated by the data acquisition request.

A characteristic value type represents the type of characteristic value to be attached to the request data. Here, in addition to the statistics calculated from the request data series, the data generation cycle at the vehicle function unit 28 from which the request data is generated may be included. The statistics may include maximum, minimum, average, median, variance, standard deviation, mode, and the like.

The characteristic value type may be indicated when it is not necessary to attach the characteristic value (that is, generate attachment data). Basically, it is necessary to generate the attachment data when the value fluctuates complicatedly instead of monotonically increasing or monotonously decreasing during the data acquisition cycle depending on the characteristic of the request data or the characteristic of the sensor detecting the request data. The request data which requires generation of attachment data depending on the characteristic of the request data includes acceleration, steering angle, engine rotation speed, and the like related to the behavior of the vehicle such as traveling, turning, stopping, and the like. The request data which requires generation of attachment data depending on the characteristics of the sensor to detect the request data includes, for example, position data of the current position detected by the GPS receiver. For example, when the request data includes an average vehicle speed or an average speed per unit time, it may be expressed using statistics representative of a speed trend such as an average value or a median value as statistics. In addition, when the request data includes the number of times of rapid acceleration or rapid deceleration per unit time, it may be expressed using the standard deviation or variance of the speed or acceleration.

The supplementary content is supplementary information according to the characteristic value type.

When the characteristic value is a statistical value, the time range (hereinafter, a calculation target period) to be calculated for the statistical value and the like is indicated as the supplementary content. The buffer data number of the ring buffer 27 is set so that instantaneous data for the maximum calculation target period that can be set as the supplementary content can be stored at least. The calculation target period may be shorter than a data acquisition period, as indicated by a sign T1 in FIG. 3. The calculation target period may be the same length as the data acquisition period, as indicated by a sign T2 in FIG. 3. The calculation target period may be longer than the data acquisition period, as indicated by a sign T3 in FIG. 3. Note that in the present embodiment, the calculation target period is set to a length greater than or equal to the data acquisition period as shown by T2 or T3.

When the characteristic value is a data generation period, the characteristic value itself is indicated as the supplementary content. The data generation period indicated as the characteristic value may be a fixed value set in advance, or it may be a set value set by the instruction when the data generation period can be set variable by the external instruction.

The multiple data attachment policies may be stored in the attachment policy DB 26 in accordance with the vehicle state. In this case, the attachment data generation unit 23 may switch the data attachment policy to be used according to the determination result of the vehicle state by the state determination unit 24.

The state determination unit 24 determines the vehicle state by acquiring necessary information from each ECU 10 via the vehicle interior communication network 11. The vehicle state that is the determination target may include, for example, a power source state (that is, on/off state), a traveling state (that is, traveling/stopping state), an operation setting (that is, state during automated driving/manual driving), and the like. In this case, the data attachment policy provided for each vehicle state is set so that a characteristic value that can accurately capture a characteristic feature of the request data detected in the vehicle state is generated as the attachment data. For example, in a case where the request data is position information, when the vehicle state indicates traveling, the characteristic value is the current position information. However, when the vehicle state indicates stopping, the characteristic value can be the position information stored at the time of stopping. In addition, in a case where the request data is the engine speed, when the vehicle state indicates the traveling, the characteristic value may be set to the instantaneous value of the rotation speed. When the vehicle state indicates the stopping, the characteristic value may be set to 0 or a fixed value.

The data collection distribution unit 22 transmits the data acquisition response including the latest request data stored in the transmission DB 25 and the characteristic value calculated for the request data to the vehicle interior application 31 that is the request source of the data acquisition request or the vehicle exterior application 7.

### 1-3. Process

### 1-3-1. Collection Distribution Process

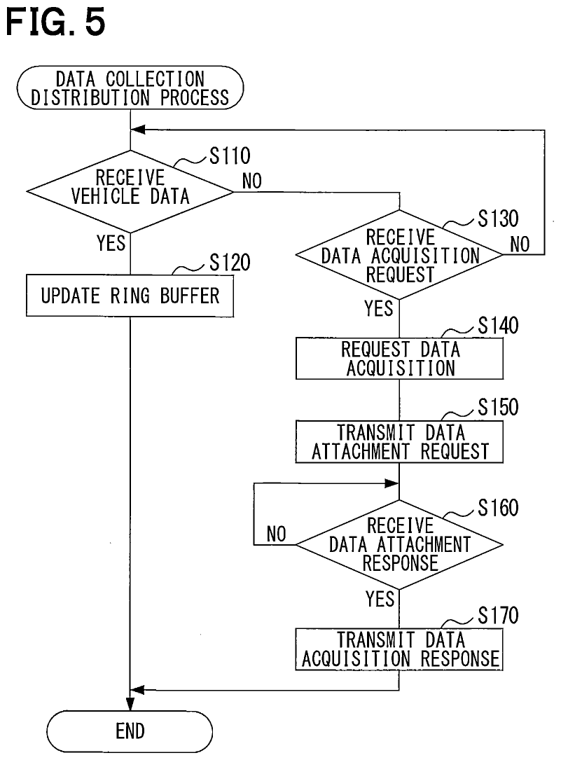

The data collection distribution process executed by the data provision platform 10a to implement the function as the data collection distribution unit 22 will be described with reference to the flowchart of FIG. 5.

The data collection distribution process is repeatedly executed when the data provision platform 10a is activated.

In S110, the data provision platform 10a normally determines whether the vehicle data has been received from the ECU 10c. When the vehicle data has been received, the process proceeds to S120. When the vehicle data has not been received, the process proceeds to S130.

In S120, the data provision platform 10a updates the ring buffer 27 with the vehicle data received in S110, and ends the process. Also, at this time, the data provision platform 10a may transmit the vehicle data received in S110 to a cloud server 51a via the transmission reception unit 21. Instead of transmitting the vehicle data at the time of receiving the vehicle data, it may be periodically performed at a certain period.

In S130, the data provision platform 10a determines whether a data acquisition request has been received from the vehicle interior application 31 or the vehicle exterior application 7. When the data acquisition request has been received, the process proceeds to S140. When the data acquisition request has not been received the process returns to S110.

In S140, the data provision platform 10a stores the latest value of the request data stored in the ring buffer 27 in the transmission DB 25.

In S150, the data provision platform 10a transmits a data attachment request to the attachment data generation unit 23. The time-series of the request data stored in the ring buffer 27 is attached to the data attachment request.

In the following S160, the data provision platform 10a determines whether a data attachment response has been received from the attachment data generation unit 23. When the data attachment response has been received, the process proceeds to S170. When the data attachment response has not been received, the same step is repeated to wait.

In S170, the data provision platform 10a transmits a data acquisition response including the latest value of the request data stored in the transmission DB 25 and the characteristic value regarding the request data to the vehicle interior application 31 that is the transmission source of the data acquisition request or the vehicle exterior application 7, and the process ends.

### 1-3-2. Data Attachment Process

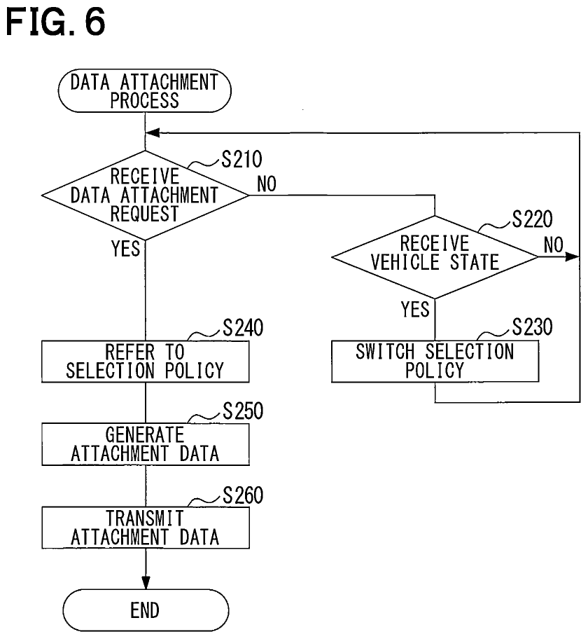

The data attachment process executed by the data provision platform 10a to implement the function as the attachment data generation unit 23 will be described with reference to the flowchart of FIG. 6.

The data attachment process is repeatedly executed when the data provision platform 10a is activated. Incidentally, at activation, among the multiple data attachment policies stored in the attachment policy DB 26, the data attachment policy facilitated for the default setting is selected. Hereinafter, the selected data attachment policy is referred to as a selection policy.

In S210, the data provision platform 10a determines whether the data attachment request has been received from the data collection distribution unit 22, and when the data attachment request has been received, the process proceeds to S240, and when the data attachment request has not been received, the process proceeds to S220.

In S220, the data provision platform 10a determines whether the vehicle state has been received from the state determination unit 24. When the vehicle state has been received, the process proceeds to S230. When the vehicle state has not been received, the process returns to S210.

In S230, when the received vehicle state has changed from the previous vehicle state, the data provision platform 10a switches the selection policy to the data attachment policy associated with the changed vehicle state, and returns the process to S210. Note that when the received vehicle state has not changed from the previous vehicle state, the process returns to S210 without switching the selection policy.

In S240, the data provision platform 10a checks the characteristic value to be generated for the request data by matching the selection policy.

In the following S250, the data provision platform 10a calculates the characteristic value confirmed in S240 based on the request data series attached to the data attachment request.

In the following S260, the data provision platform 10a stores the calculated characteristic value in the transmission DB 25 and transmits a data attachment response to the data collection distribution unit 22, and ends the process.

### 1-4. Operation

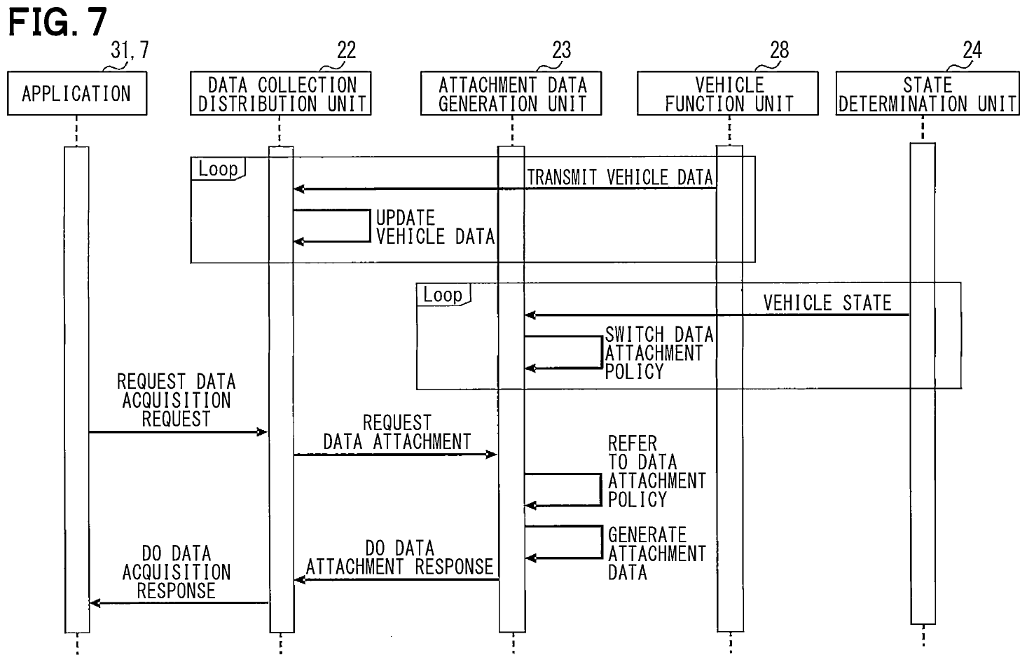

The operation of the in-vehicle system 2 will be described with reference to FIG. 7.

As shown in FIG. 7, the vehicle function unit 28 repeatedly transmits the vehicle data to the data collection distribution unit 22 for each data generation period.

The data collection distribution unit 22 updates the contents of the ring buffer 27 with the received vehicle data each time the vehicle data is received.

The state determination unit 24 periodically determines the vehicle state and transmits the determination result to the attachment data generation unit 23.

When the received vehicle state has changed from the previous vehicle state, the attachment data generation unit 23 switches, according to the vehicle state, the data attachment policy (that is, the selection policy) used when generating the attachment data.

The vehicle interior application 31 or the vehicle exterior application 7 repeatedly transmits the data acquisition request to the data collection distribution unit 22 for each data acquisition interval.

The data collection distribution unit 22 stores the latest request data stored in the ring buffer 27 in the transmission DB 25 for the vehicle data (i.e., the request data) indicated in the data acquisition request. In addition, the data collection distribution unit 22 transmits, to the attachment data generation unit 23, the data attachment request to which time-series data (that is, the request data series) accumulated in the ring buffer 27 for the request data is attached.

The attachment data generation unit 23 checks the characteristic value associated with the request data by matching the selection policy, calculates the confirmed characteristic value based on the request data series attached to the data attachment request, and stores it in the transmission DB 25. Further, the attachment data generation unit 23 transmits the data attachment response to the data collection distribution unit 22.

The data collection distribution unit 22 transmits a data acquisition response including the latest value and characteristic value of the request data stored in the transmission DB 25 to the request source vehicle interior application 31 or vehicle exterior application 7.

### 1-5. Example of Application

A specific example of an application (that is, the vehicle interior application 31 or the vehicle exterior application 7) will be described.

As a first concrete example, an application for acceleration monitoring of a delivery service will be described.

The delivery service acceleration monitoring remotely monitors whether the acceleration of a vehicle exceeds an allowable value when transporting vibration-sensitive packages such as cooking and precision equipment.

In this case, the acceleration is used as the vehicle data (that is, the request data) to be acquired by the data acquisition request, the maximum value of the acceleration is used as the characteristic value to be the attachment data, and the calculation target period is set to a length equal to the data acquisition cycle.

The acceleration has the characteristic that the value increases instantaneously during sudden braking and sudden steering. Therefore, by acquiring the maximum value in each data acquisition period, it is possible to monitor whether the allowable acceleration is exceeded. Conversely, in a case of the absence of the maximum value attachment data, unless the timing of the data acquisition request is not matched with the sudden braking or sudden steering, the sudden braking or sudden steering is missed.

As a second concrete example, a vehicle exterior application that collects data on an automated driving market will be described. In collecting data for the automated driving market, control data is collected to improve an automated driving algorithm.

In this case, acceleration, engine rotation speed, steering angle, and the like are used as the vehicle data (that is, the request data) to be acquired by the data acquisition request, and variance, and the like are used as the characteristic values to be attachment data. The calculation target period shall be set accordingly so as to obtain the minimum reliability for the characteristic value.

Acceleration, rotation speed, and steering angle are highly variable in time, and it is necessary to set the data generation interval to, for example, about tens of ms in order to accurately capture the data characteristics. On the other hand, when these request data are acquired remotely via the cloud network 5, it is difficult to make the data acquisition interval equal to or less than several hundred ms to several s for each individual in-vehicle system 2 because a large amount of data must be acquired from an unspecified number of in-vehicle systems 2. Under such a situation, the following determination can be made by using variance as the characteristic value to be attached to the request data.

It is determined that the request data with a large variance is data acquired when the value fluctuates rapidly, in other words, data acquired when the vehicle is in an unstable state, and is not meaningful on its own. The request data with a small variance is data acquired when the change of the value is small, in other words, data acquired when the vehicle is in a stable state, and it is meaningful on its own. Note that the application may try to reacquire data or increase the frequency of data acquisition when the variance is large.

As a third concrete example, an application that provides services using GPS will be described.

In this case, as the vehicle data (that is, the request data) to be acquired by the data acquisition request, the position data of the current location obtained by using the GPS is used, and the mode and the variance are used simultaneously as the characteristic values that become the attachment data. The position data by GPS may be susceptible to noise depending on the situation in the periphery of the vehicle. Therefore, it is possible to determine the reliability of the acquired request data by variance. When the reliability is low, it is attempted to reacquire the data, to replace the acquired request data with the mode added as the characteristic value, and the like.

### 1-6. Correspondence of Terms

In the present embodiment, the mobility service provision system 1 corresponds to a data provision system in the present disclosure, the in-vehicle system 2 corresponds to a data collection device in the present disclosure, and the cloud server 51 corresponds to a server in the present disclosure. The ring buffer 27 corresponds to a data storage in the present disclosure, the vehicle interior application 31 and the vehicle exterior application 7 correspond to a data use unit in the present disclosure, and the attachment policy DB 26 corresponds to an attachment policy storage in the present disclosure. The memory 512 of the cloud server 51 corresponds to a server data storage in the present disclosure. S120 corresponds to a data collection unit in the present disclosure, the ECU 10a executing the process of S140, S170 corresponds to a data provision unit in the present disclosure, and the ECU 10a executing the process of S150 to S170 corresponds to a data attachment unit in the present disclosure.

### 1-7. Effect

According to the above-described embodiment, the following effects are achieved.
(1a) When the data provision platform 10a accepts the acquisition request of the vehicle data, it transmits back the instantaneous value of the request data with a characteristic value representing the change state of the request data that occurred between the previous data acquisition request and the current data acquisition request and the like. Accordingly, regardless of the length of the data acquisition interval, the variation of the request data that occurred during the data acquisition interval can be accurately grasped by the request source application.
(1b) In the data provision platform 10a, since the data attachment policy is switched according to the vehicle state, characteristic values that accurately represent characteristics of the vehicle data according to each vehicle state can be provided to the request source application.
(1c) In the data provision platform 10a, when calculating the statistic as the characteristic value, a time range equal to or higher than the request cycle of the data acquisition request is targeted. Therefore, changes in vehicle data that occurred between the previous data acquisition request and this data acquisition request can be reflected without omission.

### 2. Second Embodiment

### 2-1. Difference from First Embodiment

The fundamental configuration of a second embodiment is similar to that of the first embodiment. Therefore, the difference therebetween will be described below. The same reference numerals as in the first embodiment denote the same elements, and reference is made to the preceding description.

In the first embodiment described above, the in-vehicle system 2 has a function to accumulate vehicle data, the function to generate attachment data regarding the requested vehicle data, and the function to provide the requested vehicle data with the attachment data to the request source applications 31, 7. In contrast, the second embodiment differs from the first embodiment in that the cloud server 51a has these functions.

### 2-2. Configuration

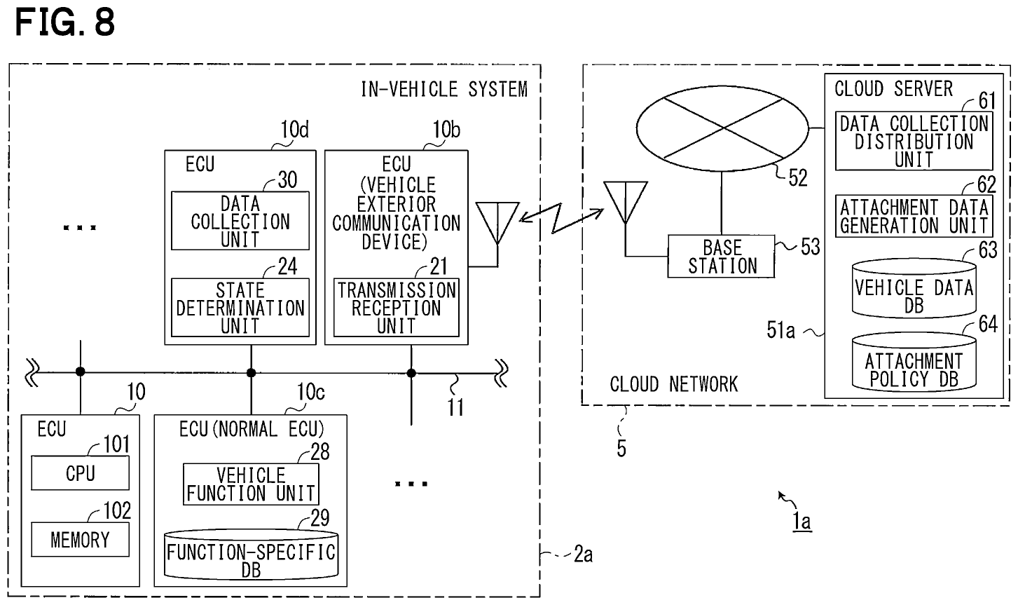

As shown in FIG. 8, the mobility service provision system 1a of the second embodiment includes an in-vehicle system 2a and a cloud network 5a.

### 2-2-1. In-Vehicle System

The in-vehicle system 2a differs from the in-vehicle system 2 in that an ECU 10d is provided instead of the ECU 10a.

The ECU 10d includes the state determination unit 24 and a data collection unit 30. The state determination unit 24 and the data collection unit 30 are implemented by processes executed by the CPU of the ECU 10d.

The state determination unit 24 is the same as that of the first embodiment.

The data collection unit 30 periodically transmits the instantaneous data received from the vehicle function unit 28 and the vehicle state determined by the state determination unit 24 to the cloud server 51a via the transmission reception unit 21. The data collection unit 30 may transmit the instantaneous data and the vehicle state to the cloud server 51 every time the instantaneous data is received from the vehicle function unit 28, and every time the vehicle state determined by the state determination unit 24 is obtained.

The vehicle interior application 31 transmits the data acquisition request to the cloud server 51a through the transmission reception unit 21, and acquires the data acquisition response from the cloud server 51a through the transmission reception unit 21. Incidentally, although the illustration in FIG. 8 is omitted, the vehicle interior application 31 is mounted in one of the ECUs 10.

### 2-2-2. Cloud Network

The cloud network 5a differs from the cloud network 5 in that the cloud server 51a is provided instead of the cloud server 51.

The cloud server 51a includes a data collection distribution unit 61, an attachment data generation unit 62, a vehicle data DB 63, and an attachment policy DB 64. The data collection distribution unit 61 and the attachment data generation unit 62 are implemented by the process executed by the CPU of the cloud server 51a. The vehicle data DB 63 and the attachment policy DB 64 are provided in the memory of the cloud server 51a.

The data collection distribution unit 61 stores the instantaneous data received from the in-vehicle system 2a through the base station 53 and the vehicle state in the vehicle data DB 63 for each vehicle and for each type of vehicle data. The vehicle data DB 63 is updated each time new instantaneous data and the vehicle state are received. The latest predetermined instantaneous data may always be stored in the vehicle data DB 63 for each vehicle and for each type of vehicle data. Note that the number of instantaneous data stored in the vehicle data DB 63 may be different for each vehicle and for each type of vehicle data, and at least the number necessary for generating the attachment data in the attachment data generation unit 62 must be stored.

The data collection distribution unit 61 accepts data acquisition requests by the vehicle interior application 31 mounted on the in-vehicle system 2a and also accepts data acquisition requests by the vehicle exterior application 7 mounted on the server or terminal device connected to the wide area wireless communication network 52. The illustration of the vehicle exterior application 7 in FIG. 8 is omitted. When the data collection distribution unit 61 accepts the data acquisition request from the vehicle interior application 31 or the vehicle exterior application 7, the request data, which is the vehicle data indicated in the data acquisition request, is extracted from the vehicle data DB 63. Incidentally, the data acquisition request is configured so as to specify the vehicle and model of the acquisition target, the type of vehicle data, and the timing when vehicle data was acquired. Accordingly, the request data extracted from the vehicle data DB 63 according to the data acquisition request (hereinafter referred to as the extract request data) includes instantaneous data at an arbitrary point in time, not only the latest instantaneous data. In addition, the data collection distribution unit 61 provides the time-series (hereinafter referred to as the request data series) of the instantaneous data including the extracted request data to the attachment data generation unit 62.

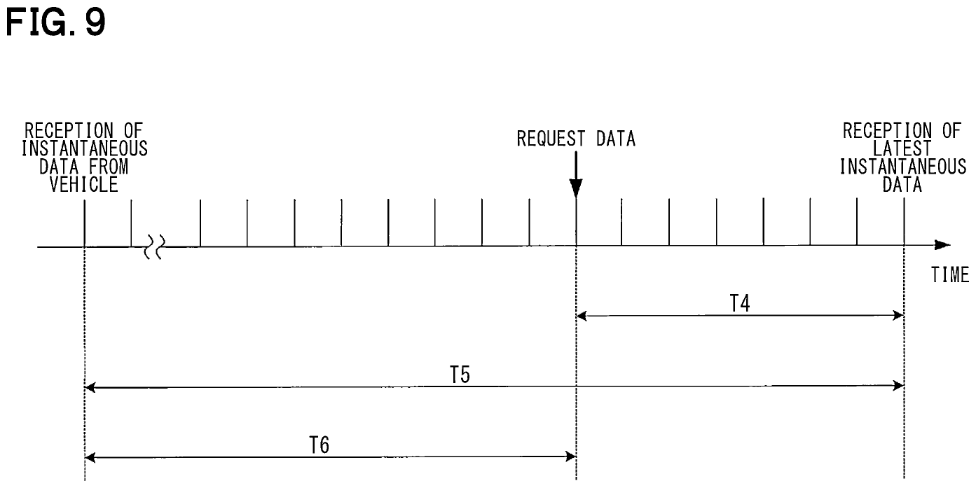

The request data series to be provided to the attachment data generation unit 62 may be instantaneous data belonging to a period T4 from the acquisition timing of the extraction request data to the acquisition timing of the latest instantaneous data, as shown in FIG. 9. In addition, the request data series may be instantaneous data including the extraction request data and belonging to a predetermined period T5 before and after the extraction request data. Further, the request data series may be instantaneous data belonging to a predetermined period T6 prior to the extraction request data.

The attachment data generation unit 62 generates characteristic values that become attachment data based on the request data series provided by the data collection distribution unit 61 in accordance with the data attachment policy stored in the attachment policy DB 64, and provides it to the data collection distribution unit 61. The characteristic value generated by the attachment data generation unit 62 is the same as the characteristic value generated by the attachment data generation unit 23 in the first embodiment.

The contents of the data attachment policy stored in the attachment policy DB 64 are the same as those stored in the attachment policy DB 26 of the first implementation. When there are multiple data attachment policies corresponding to the vehicle state, for example, the data attachment policies corresponding to the vehicle state may be selected and used according to the vehicle state stored corresponding to the extraction request data.

The data collection distribution unit 61 transmits the extraction request data and the data acquisition response including the characteristic value calculated by the attachment data generation unit 62 with respect to the extraction request data to the vehicle interior application 31 that is the request source of the data acquisition request or the vehicle exterior application 7.

### 2-3. Process

### 2-3-1. Data Collection Distribution Process

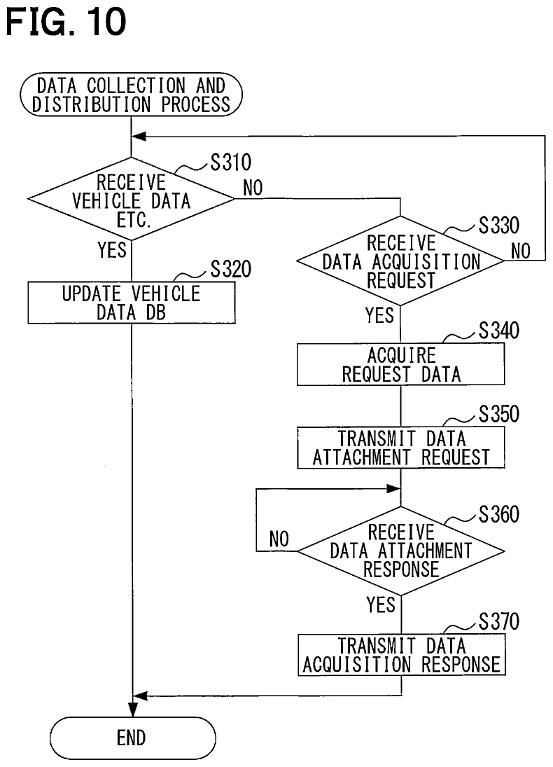

The data collection distribution process executed by the cloud server 51a to implement the function as the data collection distribution unit 61 will be described with reference to a flowchart of FIG. 10.

The data collection distribution process is repeatedly executed when the cloud server 51a is activated.

In S310, the cloud server 51a determines whether the vehicle data or vehicle state (hereinafter also referred to as vehicle data or the like) has been received from the in-vehicle system 2a. When vehicle data or the like has been received, the process proceeds to S320, and when vehicle data or the like has not been received, the process proceeds to S330.

In S320, the cloud server 51a updates the vehicle data DB 63 by the received vehicle data or the like, and ends the process.

In S330, the cloud server 51a determines whether the data acquisition request has been received from the vehicle interior application 31 or the vehicle exterior application 7. When the data acquisition request has been received, the process proceeds to S340. When the data acquisition request has not been received, the process returns to S310.

In S340, the cloud server 51a acquires the request data requested in the data acquisition request from the vehicle data DB 63.

In the following S350, the cloud server 51a transmits the data attachment request to the attachment data generation unit 62. The time-series of the request data stored in the vehicle data DB 63 is attached to the data attachment request.

In the following S360, the cloud server 51a determines whether a data attachment response has been received from the attachment data generation unit 62. When the data attachment response has been received, the process proceeds to S370. When the data attachment response has not been received, the same step is repeated to wait.

In S370, the cloud server 51a transmits the data acquisition response including the request data acquired by S340 and the characteristic value regarding the request data received in S360 to the vehicle interior application 31 that is the transmission source of the data acquisition request or the vehicle exterior application 7, and the process ends.

### 2-3-2. Data Attachment Process

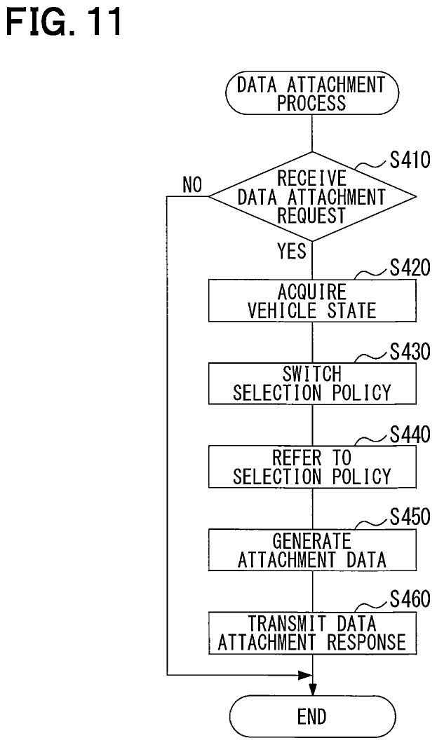

The data attachment process executed by the cloud server 51a to implement the function as the attachment data generation unit 62 will be described with reference to a flowchart of FIG. 11.

The data attachment process is repeatedly executed when the cloud server 51a is activated. Incidentally, at the activation, among the multiple data attachment policies stored in the attachment policy DB 64, the data attachment policy facilitated for the default setting is selected. Hereinafter, the selected data attachment policy is referred to as the selection policy.

In S410, the cloud server 51a determines whether the data attachment request has been received from the data collection distribution unit 61. When the data attachment request has been received, the process proceeds to S420. When the data attachment request has not been received, the process ends.

In S420, the cloud server 51a acquires the vehicle state associated with the request data from the vehicle data DB 63 in accordance with the request data indicated in the data attachment request.

In the following S430, the cloud server 51a switches the selection policy to the data attachment policy associated with the changed vehicle state when the vehicle state acquired in S420 has changed from the previous vehicle state.

In the following S440, the cloud server 51a checks the characteristic value to be generated for the request data by matching the selection policy.

In the following S450, the cloud server 51a calculates the characteristic value confirmed in S430 based on the request data series attached to the data attachment request.

In the following S460, the cloud server 51a sends back the data attachment response including the calculated characteristic value to the data collection distribution unit 61, and the process ends.

### 2-4. Correspondence of Terms

In the present embodiment, the mobility service provision system 1a corresponds to the data provision system in the present disclosure, the in-vehicle system 2a corresponds to the data collection device in the present disclosure, and the cloud server 51a corresponds to the server in the present disclosure. The vehicle data DB 63 corresponds to the vehicle data storage in the present disclosure, the cloud server 51a executing the process of S340 and S370 corresponds to the data provision unit, and the cloud server 51a executing the process of S350 to S370 corresponds to the data attachment unit.

### 2-5. Effects

According to the second embodiment described above, it has the same effects as the effects (1a) to (1c) of the first embodiment described above, and furthermore, it has the following effects.
(2a) In the second embodiment, since the cloud server 51a has the function as the data provision platform 10a, it is possible to simplify the process of the in-vehicle system 2a.

### 3. Other Embodiments

Although the embodiments of the present disclosure have been described above, the present disclosure is not limited to the embodiment described above, and various modifications can be made to implement the present disclosure.
(3a) In the first embodiment described above, the method of acquiring the data attachment policy is not particularly limited, but it may be configured to perform acquisition from the cloud server 51, for example, every time the in-vehicle system 2 is activated.
(3b) In the embodiments described above, the data attachment policy is switched according to the vehicle state, but a single data attachment policy may be used regardless of the vehicle state.
(3c) The data attachment policy may be prepared separately for each user who provides applications, each user using applications, or each request source application.
(3d) In the embodiments described above, fixed data such as data generation period is listed as one of the characteristic values. This fixed data may be a value (that is, a value that cannot be set from the outside) representing a characteristic specific to the normal ECU 10c that is the data provision source. In addition, the fixed data may be a value (that is, a value that can be set from an outside) that can change the control and the like according to the setting in the normal ECU 10c from which the data is provided.
(3e) In the embodiments described above, in addition to the instantaneous value of the request data, the characteristic value of the request data generated in accordance with the data attachment policy is returned to the request source application. However, in cases where the instantaneous value itself does not hold significant meaning, such as detection of signs of noise environment degradation, the occurrence of sudden braking, or abnormalities in vehicle functions, the system may be configured to omit the instantaneous value and return only the characteristic value to the request source application.
(3f) In the embodiments described above, the attachment data generation units 23, 62 generate the characteristic value after receiving the data acquisition request. On the other hand, when the processing ability and the storage capacity of the data provision platform 10a and the cloud server 51a are available, various characteristic values may be generated and stored in the database each time vehicle data is acquired from the normal ECU 10c. In this case, when the data acquisition request is received, the characteristic value stored in the database is read out and sent back.
(3g) In the embodiments described above, when there is the data acquisition request, the characteristic value is added by referring to the data attachment policy. For example, it may be configured so that it is possible to specify whether to attach the characteristic value in the data acquisition request, and refer to the data attachment policy only when it is indicated that it is necessary to attach the characteristic value in the data acquisition request.
(3h) In the first embodiment described above, the data collection distribution unit 22, the attachment data generation unit 23, and the state determination unit 24 are provided in one ECU 10 (that is, the data provision platform 10a), but they may be provided in different ECUs 10.
(3i) The ECU 10 and the methods described in the present disclosure may be implemented by a dedicated computer provided by configuring a processor and memory programmed to perform one or more functions embodied by a computer program. Alternatively, the ECU 10 and the method described in the present disclosure may be implemented by a dedicated computer provided by configuring a processor with one or more dedicated hardware logic circuits. Alternatively, the ECUs 10 and the method described in the present disclosure may be implemented by one or more dedicated computers configured by combinations of processors and memories programmed to perform one or more functions and processors configured by one or more hardware logic circuits. The computer program may be stored in a computer-readable non-transitory tangible storage medium as instructions to be executed by a computer. The method for implementing the functions of the respective units included in the ECU 10 does not necessarily need to include software, and all of the functions may be implemented by use of one or more hardware.
(3j) Multiple functions of one element in the above embodiment may be implemented by multiple elements, or one function of one element may be implemented by multiple elements. In addition, multiple functions of multiple components may be implemented by one component, or a single function implemented by multiple components may be implemented by one component. Part of the configuration of the above embodiment may be omitted. At least a part of the configuration in one embodiment may be added to or substituted for the configuration of another embodiment.

In attachment to the above-described data provision platform 10a, the present disclosure can be implemented in various forms, such as a data provision system that includes the data provision platform 10a as a component, a program to make a computer function as the data provision platform 10a, or a non-transitory tangible storage medium like a semiconductor memory that stores this program.

What is claimed is:

1. A data provision platform comprising:
a data collection unit configured to repeatedly acquire instantaneous data that is an instantaneous value of vehicle data transmitted from each unit of a vehicle;
a data storage configured to store a time-series of the instantaneous data acquired by the data collection unit;
a data provision unit configured to, when accepting a data acquisition request from at least one data use unit configured to execute a process using the vehicle data,
extract the instantaneous data of a request data that is the vehicle data indicated by the data acquisition request, the instantaneous data being stored in the data storage, and
provide the instantaneous data to the data use unit; and
a data attachment unit configured to attach a characteristic value to the instantaneous data provided by the data provision unit to the data use unit, the characteristic value being: specified in advance according to the request data and generated based on the time-series of the instantaneous data stored in the data storage,
wherein
the time-series of the instantaneous data includes the instantaneous data acquired in a period from a previous data acquisition request to a current data acquisition request.

2. The data provision platform according to claim 1, wherein
the data storage is configured to store the instantaneous data for a certain period determined for each type of the vehicle data.

3. The data provision platform according to claim 1, wherein
one of the characteristic value is a data generation cycle that is a cycle in which the vehicle data is generated by a generation source of the vehicle data.

4. The data provision platform according to claim 1, wherein
one of the characteristic value is a statistic calculated based on the instantaneous data accumulated within a time range set for each type of the vehicle data.

5. The data provision platform according to claim 4, wherein
the time range is set to a period equal to or more than a period between a previous data acquisition request and a current data acquisition request.

6. The data provision platform according to claim 1, wherein
the data attachment unit attaches the characteristic value to the instantaneous data when a request interval is longer than a data generation cycle that is a cycle for generating the vehicle data requested by the data acquisition request, the request interval being an interval for receiving the data acquisition request from one data use unit.

7. The data provision platform according to claim 1, further comprising:
an attachment policy storage configured to store a data attachment policy indicating information related to generation of the characteristic value in association with the vehicle data; and
an attachment data generation unit configured to generate the characteristic value associated with the request data in the data attachment policy based on the time-series of the instantaneous data stored in the data storage.

8. The data provision platform according to claim 7, further comprising
a state determination unit configured to determine a vehicle state,
wherein
the attachment data generation unit is configured to switch the data attachment policy used for generating the characteristic value according to the vehicle state determined by the state determination unit.

9. A data provision system comprising:
a data collection device communicably connected to an electronic control unit of a vehicle; and
a server communicably connected to the vehicle,
wherein
the data collection device includes:
a data collection unit configured to
repeatedly acquire instantaneous data that is an instantaneous value of vehicle data transmitted from each unit of a vehicle, and
transmit the acquired instantaneous data to the server;
a data storage configured to store a time-series of the instantaneous data acquired by the data collection unit;
a data provision unit configured to, when accepting a data acquisition request from at least one data use unit configured to execute a process using the vehicle data,
extract the instantaneous data of a request data that is the vehicle data indicated by the data acquisition request, the instantaneous data being stored in the data storage, and
provide the instantaneous data to the data use unit; and
a data attachment unit configured to attach a characteristic value to the instantaneous data provided by the data provision unit to the data use unit, the characteristic value being: specified in advance according to the request data and generated based on the time-series of the instantaneous data stored in the data storage, and
the server includes a server data storage configured to store the time-series of the instantaneous data transmitted from the vehicle,
wherein
the time-series of the instantaneous data includes the instantaneous data acquired in a period from a previous data acquisition request to a current data acquisition request.

10. A data provision system comprising:
a data collection device communicably connected to an electronic control unit of a vehicle; and
a server communicably connected to the vehicle,
wherein
the data collection device includes
a data collection unit configured to
repeatedly acquire instantaneous data that is an instantaneous value of vehicle data transmitted from each unit of a vehicle, and
transmit the acquired instantaneous data to the server, and
the server includes:
a vehicle data storage configured to store a time-series of the instantaneous data received by the data collection device;
a data provision unit configured to, when accepting a data acquisition request from at least one data use unit configured to execute a process using the vehicle data,
extract the instantaneous data of a request data that is the vehicle data indicated by the data acquisition request, the instantaneous data being stored in the vehicle data storage, and
provide the instantaneous data to the data use unit; and
a data attachment unit configured to attach a characteristic value to the instantaneous data provided by the data provision unit to the data use unit, the characteristic value being: specified in advance according to the request data and generated based on the time-series of the instantaneous data stored in the data storage,
wherein
the time-series of the instantaneous data includes the instantaneous data acquired in a period from a previous data acquisition request to a current data acquisition request.

11. A data provision method comprising:
repeatedly acquiring instantaneous data that is an instantaneous value of vehicle data transmitted from each unit of a vehicle;
storing a time-series of the instantaneous data in a data storage;
when accepting a data acquisition request from at least one data use unit configured to execute a process using the vehicle data, extracting the instantaneous data of a request data that is the vehicle data indicated by the data acquisition request, the instantaneous data being stored in the data storage;
providing the instantaneous data to the data use unit; and
attaching a characteristic value to the instantaneous data provided to the data use unit, the characteristic value being: specified in advance according to the request data and generated based on the time-series of the instantaneous data stored in the data storage,
wherein
the time-series of the instantaneous data includes the instantaneous data acquired in a period from a previous data acquisition request to a current data acquisition request.

12. A non-transitory computer-readable storage medium storing a program causing a computer to:
repeatedly acquire instantaneous data that is an instantaneous value of vehicle data transmitted from each unit of a vehicle and storing a time-series of the instantaneous data in a data storage;
when accepting a data acquisition request from at least one data use unit configured to execute a process using the vehicle data, extract the instantaneous data of a request data that is the vehicle data indicated by the data acquisition request, the instantaneous data being stored in the data storage, and provide the instantaneous data to the data use unit; and
attach a characteristic value to the instantaneous data provided to the data use unit, the characteristic value being: specified in advance according to the request data and generated based on the time-series of the instantaneous data stored in the data storage,
wherein
the time-series of the instantaneous data includes the instantaneous data acquired in a period from a previous data acquisition request to a current data acquisition request.
